(19) United States
(12) Patent Application Publication
(10) Pub. No.: US 2008/0184334 A1
(43) Pub. Date: Jul. 31, 2008

(54) Sealing electronic content

(75) Inventors: Cedric R.J. Hebert, Mougins (FR); Frederic Montagut, Antibes (FR); Laurent Y. Gomez, Le Cannet (FR); Cedric S.P. Ulmer, Nice (FR)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/715,219

(22) Filed: Mar. 6, 2007

(30) Foreign Application Priority Data
Jan. 30, 2007 (EP) 07290128.3

(51) Int. Cl. H04L 9/00; H04L 9/30

(52) U.S. Cl. 726/1; 380/30

(57) ABSTRACT

A method includes associating an access policy with content. The access policy specifies at least one access condition to be satisfied prior to a content recipient accessing the content. An encryption key is provided to a content source, the encryption key being associated with the access policy and to be used by the content source to encrypt the content. At a trusted third party, the determination is made regarding whether the at least one access condition is satisfied. A decryption key is selectively provided from the trusted third party to the content recipient based on the at least one access condition being satisfied. The decryption key is associated with the access policy and may be used by the content recipient to decrypt the content.

### CLAIM OF PRIORITY

The present patent application claims the priority benefit of the filing date of European Application (EPO) No. 07290128.3 filed Jan. 30, 2007, the entire content of which is incorporated herein by reference.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyright© 2007 SAP AG. All Rights Reserved.

### TECHNICAL FIELD

The present document relates generally to the technical field of data access and programming and, in one example, to sealing electronic content.

### BACKGROUND

Certain business processes, for example, may require data to be sent to an entity ahead of the relevant entity being authorized to access this data. Examples of such business processes include calls for tenders, disclosure of a last will or testament, deposit of ideas proving anteriority in the case of plagiarism issues, and similar processes where data is advantageously kept in a state that guarantees the data will not be disclosed to a recipient until conditions are met.

### BRIEF DESCRIPTION OF THE DRAWINGS

Some embodiments are illustrated by way of example and not limitation in the figures of the accompanying drawings in which:

FIG. 1 is a block diagram illustrating a system, according to an example embodiment, to electronically seal content (e.g. electronic documents).

FIG. 2 is a table diagram illustrating a policy table and a condition table, according to an example embodiment, that may be maintained within a policy database of the system to seal electronic content.

FIG. 3 is a swimlane flow chart illustrating a method, according to an example embodiment, to create an electronic seal to be applied to electronic content.

FIG. 4 is a swimlane flow chart illustrating a method, according to an example embodiment, to open an electronic seal applied to electronic content.

FIG. 5 is a block diagram providing a diagrammatic representation of a machine, in the example form of a computer system.

### DETAILED DESCRIPTION

Example methods and systems are described. In the following description, for purposes of explanation, numerous specific details are set forth in order to provide a thorough understanding of example embodiments. It will be evident, however, to one skilled in the art that the present invention may be practiced without these specific details.

The publication BAGA et. al., “POLICY-BASED CRYPTOGRAPHY AND APPLICATIONS”, discusses a concept of policy-based cryptography which may be used to perform policy enforcement in large-scale open environments (e.g., the Internet). BAGA et. al. describes policy-based encryption as allowing the encryption of data according to a policy, so that only entities fulfilling the policy are able to successfully perform decryption and retrieve the plain text data.

U.S. Pat. No. 6,246,991 describes a will information management and disclosure system which keeps in custody a depositor's last will and testament. This document is unsealed in accordance with unsealing conditions registered in advance by a depositor, and disclosed to predetermined recipients. A host processing system unseals depositor information (e.g., the depositor's last will and testament) in accordance with the predetermined unsealing conditions. The host processing system also includes a recipient-specified delivery part for disclosing the depositor information to recipients designated in advance by the depositor and satisfying predetermined conditions. Accordingly, the “unsealing” on the deposit information is performed by an unsealing part of the host processing system.

U.S. Pat. No. 6,324,650 discusses a system for controlling the disclosure of sensitive information. The disclosure is controlled in that sensitive information is not disclosed until predefined conditions are met (e.g., the passage of a certain time without an authorized update request for secrecy), and in that copies of the information are protected by encryption and by widespread, unpredictable storage, so that at least one copy will be available when disclosure is required. Disclosure is further controlled in that the information is kept secret until disclosure is required, and when disclosure is required, the information is sent to predefined destinations (e.g., email addresses and posted on websites) in a predefined format.

A number of technical problems and constraints exist within the above discussed technologies. For example, with respect to the technology discussed in U.S. Pat. No. 6,324,650, as a number of different versions or instantiations of the sensitive information are encrypted and stored using widespread, unpredictable storage, each version is encrypted with a respective public key (e.g., the intended recipient's public key). Accordingly, this condition is not scalable to a large number of recipients or storage locations. Further, each recipient or storage location requires a dedicated key pair, which needs to be retained between encryption and decryption events.

A second technical issue, particularly present in the technology described in U.S. Pat. No. 6,324,650, is that of disclosure control. Specifically, as the sensitive information is not delivered until the disclosure or access conditions are met, the possibility of the sensitive information being revoked, altered, or tampered with prior to delivery exists.

U.S. Pat. No. 5,586,186 describes a system for controlling unauthorized access to information distributed to users, and more particularly for controlling unauthorized access to software distributed to users. The described method enables software to be encrypted utilizing a single encryption key, and to be decrypted using a multiplicity of decryption keys, each of which is unique to a particular user. In the background section of this patent, a discussion is provided regarding the encryption of application programs on a CD-ROM using a single encryption key, and providing users with the corresponding decryption key once they have purchased a particular program. Specifically, when a user decides to purchase an application program stored on a CD-ROM, the user is able to call the vendor, give the vendor the user's credit card number, and receive a decryption key from the vendor. The background section of this reference points out that a user who has purchased an application program can reveal the decryption key to others who have not purchased the program, and thus compromise the security provided by the encryption.

### DEFINITIONS

As used herein, the term “content” may refer to any form of digital or electronic content and may include, for example, a digital document data (e.g., a WORD® document, a Portable Document Format (PDF) document, a HyperText Markup Language (HTML) document, a Rich Text Format (RTF) document or an eXtensible Markup Language (XML) document), digital image data (e.g., a Joint Photographic Experts Group (JPEG) format file, a Tagged Image File Format (TIFF) file, a Portable Network Graphics (PNG) file, a Graphics Interchange Format (GIF) file etc.), digital audio data (e.g., Windows Media Audio (WMA) data, Waveform (WAV) data, Pulse-Coded Modulation (PCM) data, Audio Interchange File Format (AIFF) data, Advanced Audio Coding (AAC) data etc.), or digital video data (e.g. Advanced Division Systems Committee (ADSC) data, Digital Video Broadcast (DVB) data or Integrated Services Digital Broadcasting (ISDB) digital data, or MPEG data).

Further, as used in herein, the term “policy” may refer to any definition or a statement of at least one condition, rule or the like applicable to an identified process or interaction.

Overview

This overview is intended to provide an overview of the subject matter of the present patent application. It is not intended to provide an exclusive or exhaustive explanation of the invention.

As noted above, certain business processes, for example, require data to be sent to the receiving entity prior to the receiving entity actually being authorized to access that data. In such cases, the receiving entity may only be permitted to access the data once a certain condition (or conditions) is met. Examples of such business processes include calls for tenders, disclosures of last wills and testaments, depositing ideas for proving anteriority in the case of plagiarism issues and other processes where the data should be kept in a state that guarantees the data will not be disclosed unless and until the relevant condition is met. At the same time, it may be desirable to prevent an originator or source of the digital data from altering or revoking this digital data before it is disclosed.

An example embodiment seeks to address, inter alia, the above issues. To this end, an example embodiment offers a mechanism to ensure that an entity participating in a condition-constrained process will not violate constraints by performing an illegal disclosure of, or by performing an illegal access to, received electronic content (e.g. documents), while at the same time allowing the receiving entity to receive and maintain the digital data.

In one example embodiment, there is proposed a three-part deployment scheme that includes a content source comprising an entity that sends the digital data, a content recipient comprising an entity that receives and holds the digital data, and a trusted third party comprising an entity that operates to enforce one or more disclosure or access conditions pertaining to the digital data.

Assuming that the content source wishes to participate in a process (e.g., a call for tender) that requires the submission of electronic data (e.g., a tender document) to the content recipient, the content source may first perform a handshake with the trusted third party. This handshake may be initiated utilising a Policy-Based Cryptography Protocol, or any similar protocol. The trusted third party then provides the content sender with an access-restricting mechanism (or data) in the form of encryption key (e.g., a public key. The encryption key may be derived from a policy defining the conditions to be met before the digital content, to be delivered to the content recipient, can be accessed (e.g., decrypted). This policy may, in various embodiments, be defined by the content source, the content recipient, or a combination of the content source and content recipient. Alternatively, the policy may be defined by some third party that is exercising control over the interaction between the content source and the content recipient.

Having received the encryption key, the content source then encrypts the digital content with this key, and sends the encrypted digital content to the content recipient. When wishing to access the encrypted digital content, the content recipient requests an access-enabling mechanism (or data) in the example form of a decryption key (e.g., a private key corresponding to the public key delivered to the content source) from the trusted third party. The trusted third party will at this point determine whether an access condition, specified by the access policy, has been satisfied. The trusted third party will then send the decryption key to the content recipient, if it is determined that the relevant access condition (or access conditions) has been met. The content recipient is then able to utilize the decryption key to decrypt and access the digital content.

In an embodiment, the trusted third party may also perform continual or periodic monitoring of the access condition to determine whether it is satisfied. In this case, the trusted third party may automatically send the decryption key in an unsolicited manner to the content recipient when the trusted third party determines that the access condition has been satisfied.

### Example Embodiments

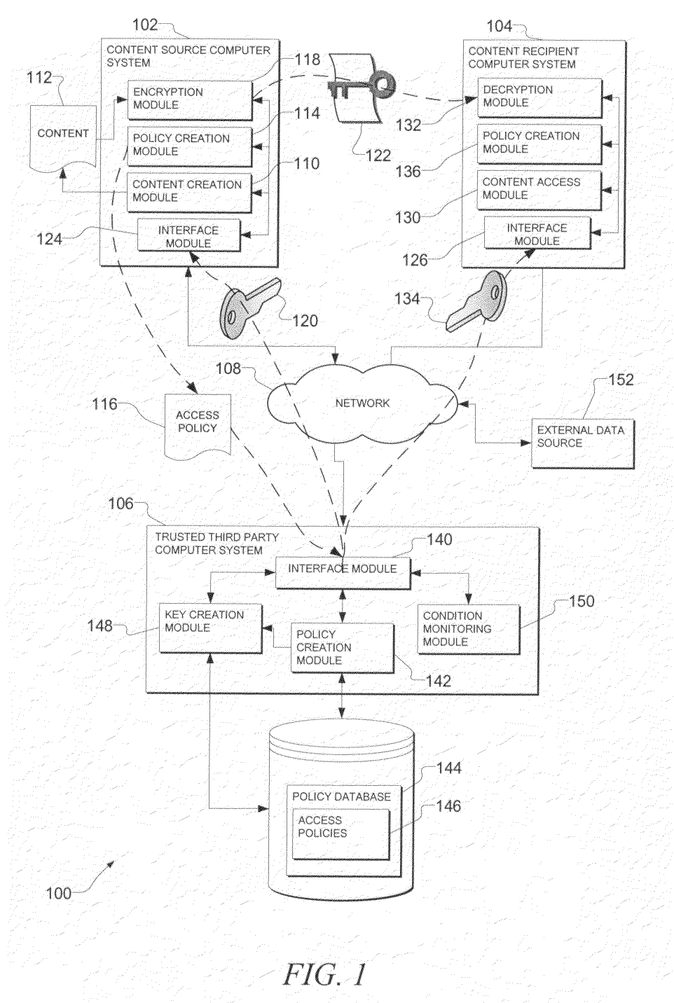

FIG. 1 is a block diagram illustrating a system 100, according to an example embodiment, to selectively enable access to content, previously delivered to a content recipient, upon satisfaction of a condition associated with access to the content.

The system 100 includes a content source computer system 102, a content recipient computer system 104, and a trusted third party computer system 106, which are communicatively coupled by a network 108 (e.g., a Local Area Network (LAN), a Wide Area Network (WAN), or the Internet). The content source computer system 102, in an example embodiment, operates as a source of electronic content that is provided, via the network 108, to the content recipient computer system 104. The trusted third party computer system 106 operates, via the network 108, to enforce an access policy pertaining to access by the content recipient computer system 104 of electronic content delivered to that computer system 104 from the content source computer system 102.

Turning specifically to the content source computer system 102, an optional content creation module 110 (e.g., an instance of MICROSOFT WORDS®) may facilitate the creation of electronic content 112 at the content source computer system 102. The creation of the electronic content 112 may be performed entirely manually, using a combination of automated or manual input, or in an entirely automated fashion. It will be appreciated that the electronic content 112 need not necessarily be created at the content source computer system 102, and may be received from some other source, prior to the content source computer system 102 providing this electronic content 112 to the content recipient computer system 104.

The content source computer system 102 further includes a policy creation module 114 to facilitate the specification and definition of an access policy 116. The access policy 116 may include one or more access conditions upon which access, for example by the content recipient computer system 104, to the electronic content 112 is regulated or contingent. As will be described in further detail below, in other embodiments, policy creation modules may also reside at the content recipient computer system 104 and/or the trusted third party computer system 106 so as to enable users of these computer systems to author, or participate in the authorship of, an access policy 116 with respect to electronic content 112.

The content source computer system 102 further includes an encryption module 118 that operationally encrypts the electronic content 112, utilizing an encryption key 120 received via the network 108 from the trusted third party computer system 106. The encryption of the content 112 using the encryption key 120 results in the generation of encrypted electronic content 122 that is communicated from the content source computer system 102, via the network 108, to the content recipient computer system 104.

Finally, the content source computer system 102 also includes an interface module 124, communicatively coupled to each of the content creation module 110, the policy creation module 114 and the encryption module 118 so as to enable input to these modules from computer systems coupled to the network 108, and so as to facilitate output from these respective modules to other computer systems coupled to the network 108.

The content recipient computer system 104 similarly includes an interface module 126, so as to enable modules of the content recipient computer system 104 to communicate with other entities via the network 108. A content access module 130 (e.g. MICROSOFT WORD®) enables the content recipient computer system 104 to access content delivered thereto via the network 108. The content recipient computer system 104 may also be coupled to a local storage facility (not shown) so as to enable the content access module 130 to store content (e.g., both encrypted and decrypted content) locally. A decryption module 132 operates to decrypt the encrypted electronic content 122, utilizing a decryption key 134, received via the network 108 from the trusted third party computer system 106.

The content recipient computer system 104 may also include a policy creation module 136 to enable a user of the content recipient computer system 104 to author, or participate in the authorship of, an access policy 116 pertaining to the electronic content 112. In other embodiments, the access policy need not be locally authored and could be received at the content recipient computer system 104 from another location or entity.

The trusted third party computer system 106 also includes an interface module 140 to enable interfacing by the various modules of the trusted third party computer system 106 with other entities coupled to the network 108. A policy creation module 142 may be accessed by an operator of the trusted third party computer system 106, or may be accessed remotely, via the network 108, by operators of the computer systems 102 or 104. The policy creation module 142 may be utilized to locally author the access policy 116 at the trusted third party computer system 106. In a further embodiment the policy creation modules 114, 136 and 142 of the computer systems 102, 104 and 106 may enable a collaborative authoring of an access policy 116.

The policy creation module 142 is shown to be coupled to a policy database 144, in which are stored a collection 146 of access policies enforced by the trusted third party computer system 106.

A key creation module 148 operates to generate the encryption and decryption keys 120 and 134 (e.g., an asymmetrical public/private key pair). In an example embodiment, the keys 120 and 134 are derived from decryption conditions specified in the access policy 116. The key creation module 148 communicates the keys 120 and 134 to the content source computer system 102 and the content recipient computer system 104 respectively, via the appropriate interface modules and the network 108.

A condition monitoring module 150, in an example embodiment, operates to monitor access conditions specified within access policies of the collection 136 of access policies stored in the policy database 144. This monitoring may be performed responsive to a request received from an entity (e.g., the content recipient computer system 104) to access the electronic content 112, or may automatically be performed on a periodical continuous basis without receiving a specific request from an entity.

In various embodiments, the condition monitoring module 150 may operate to monitor certain self-generated data (e.g., time and date data) to assess whether a particular access condition has been satisfied or not. The condition monitoring module 150 may also, via the interface module 140 and the network 108, monitor one or more external data sources 152 with a view to assessing access conditions specified by access policies. It will be appreciated that the external data sources 152 may be any number of external data sources, and depend on the nature of the interaction between the content source computer system 102 and the content recipient computer system 104, as well as the nature of the electronic content 112, merely for example.

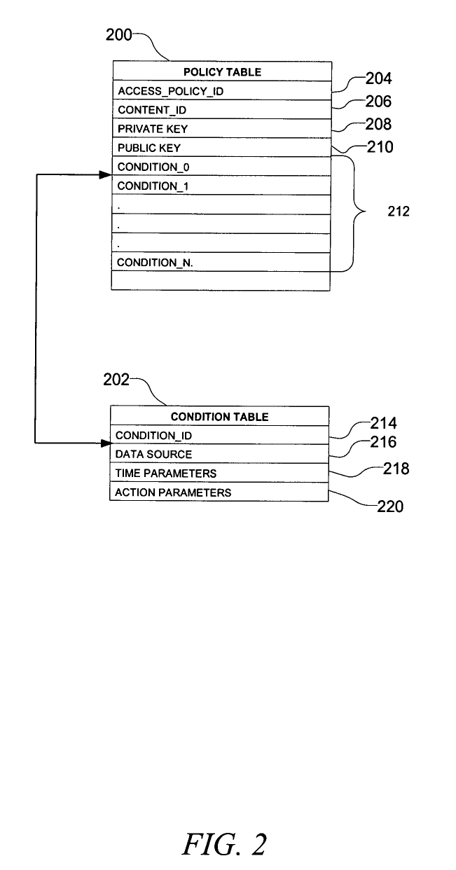

FIG. 2 is a table diagram illustrating a policy table 200, and an associated condition table 202, within which data constituting the collection 146 of access policies may be stored in the policy database 144. As noted above, in an example embodiment, each access policy is associated with a respective instance of content, and specifies one or more conditions that should be satisfied prior to a content recipient computer system 104 being granted access to the relevant instance of digital content.

To this end, for each access policy, the access policy table 200 stores a record including an access policy identifier 204, and a content identifier 206 for an associated instance of digital content. Further, the policy table 200 may store an encryption key in the example form of a private key 208, and a decryption key in the example form of a public key 210 for each access policy. The public and private keys 208 and 210 may, as mentioned above, be generated by the key creation module 148 based on conditions included within a respective access policy.

Further, each access policy record within the policy table 200 may include a number of condition identifiers 212, each condition identifier indexing to a corresponding condition, as stored in the condition table 202.

Each record within the condition table 202 includes a condition identifier 214, a data source identifier 216, identifying a data source (e.g., internal or external) from which data to be evaluated in terms of the condition is retrieved, as well as any number of time parameters 218 and/or action parameters 220. For example, the time parameters 218 may specify temporal conditions that should be satisfied prior to the relevant condition being satisfied, and the action parameters 220 may specify certain events for actions that should have occurred in order for the relevant condition to be satisfied. Other example parameters may include state parameters (e.g., specifying a state for a data source, such as evidence documents) based on which the condition may be evaluated.

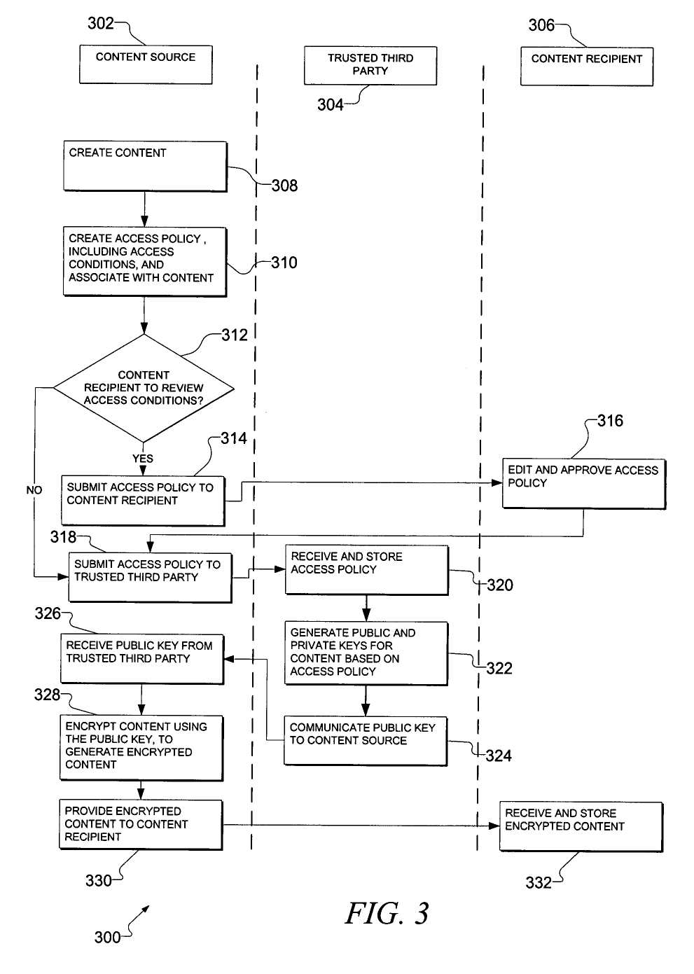

FIG. 3 is a swimlane flowchart illustrating a method 300, according to an example embodiment, to electronically seal digital content utilizing an access policy. The swimlane flowchart shows certain operations being respectively performed by a content source 302, a trusted third party 304 and a content recipient 306. While the various operations of the method 300 are described as being performed by these respective entities, it will be appreciated that in other embodiments, operations may be performed by entities other than those reflected in FIG. 3. For example, certain operations that are described below as being performed by content source 302 may, in other embodiments, be performed by the trusted third party 304 or the content recipient 306.

The method 300 commences at operation 308 with the creation of the electronic content 312 at the content source computer system 102 by the content creation module 110. For example, where the content creation module 100 includes the MICROSOFT WORD® application, the content creation may be the authoring of a response to an RFQ, or the authoring of a last will and testament. In other embodiments, where the content creation module 110 is an image, audio or a video editing application, the content creation may include the creation of an image, audio or video file. Of course, the content need not be created at the content source 302, but could be received at the content source 302 from another entity that has created the relevant content.

At operation 310, the content source 302, for example utilizing the policy creation module 114, may create access policy 116, and associate the access policy 116 with a particular instance of the electronic content 112. This association of the access policy 116 with a particular instance of electronic content 120 may comprise the act of communicating the access policy together with an associated content identifier to the trusted third party 304.

The created access policy 116 may specify one or more access conditions to be satisfied prior to the content recipient 306 being granted access to the content 112. In one embodiment, a definition of the conditions by the content source 302 may include the specification of conditions under which the electronic content will be authorized to be decrypted by the content recipient. The process for definition of such conditions may include defining a set of conditions that the trusted third party 304 should verify, prior to the trusted third party 304 sending a decryption key 134 to the content recipient 306.

The various access (or disclosure) conditions included within the access policy 116 may consist of one or more atomic elements. In a simple example, an access condition may consist of a single information item, such as a date. In a more complex example, an access policy 116 may consist of a set of conditions that may rely on a context that the trusted third party 304 is equipped to analyze and verify. Accordingly, in various embodiments, an access condition set embodied within a particular access policy 116 may be as complex as the number and scope of elements that the trusted third party 304 can check and verify. For example, where the content 112 is a last will and testament, the trusted third party 304 may be required to access an online database of deceased persons in order to assess an access condition that requires verification of the death of the testator.

While in one embodiment, the access policy 116 may be defined by the content source 302 alone, in another embodiment, the content recipient 306 may provide the content source 302 with the conditions to be included in the access policy 116. In further embodiments, the content recipient 306 may be tasked with creation of the access policy 116. For example, consider that where the content recipient has issued a number of RFQs, the content recipient 306 may wish to assure responders to the RFQs that certain conditions will apply uniformly across the process. In this case, the content recipient 306 may author the access policy 116, and distribute it to the content sources 302 for review and application to the content. In yet a further embodiment, a trusted third party 304 may author an access policy 116 to be associated with the content 112.

Where the trusted third party 304 is operating as a facilitator of the provision of the content 112 from the content source 302 to the content recipient 306, the trusted third party may in fact host a policy creation module 142, as illustrated in FIG. 1, to which the content source 302 has access via the network 108, and utilizing which the content source 302 can create the relevant access policy 116.

Returning to the method 300 illustrated in FIG. 3, at decision operation 312, the content source 302, and specifically the policy creation module 114, may make a determination as to whether the content recipient 306 is required to review the access conditions of the access policy 116. This determination may be made by the policy creation module 114 based on information previously received from the content recipient computer system 104, or information stored within the policy database 144.

In the event of a positive determination at decision operation 312, the content source 302 submits, at operation 314, the access policy 116 to the content recipient 306. At operation 316, the content recipient 306, using the policy creation module 136 (or the policy creation module 142 of the trusted third party 304), may edit and approve the access policy 116. This process may involve a negotiation between the content source 302 and the content recipient 306. It will of course be appreciated in any number content sources and content recipients may be involved in a specific process. Accordingly, this negotiation process may be repeated on a per partner pair basis.

Following completion of operation 316, or following a negative determination at decision operation 312, the content source 302, at operation 318, initiates a communication with the trusted third party 304. The content source 302 then provides the access policy 116, including an appropriately defined condition set, to the trusted third party 304.

At operation 320, the trusted third party 304 receives the access policy 116 via the network 108, and proceeds to store the access policy within the collection 146 of access policies within the policy database 144.

At operation 322, the key creation module 148 of the trusted third party 304 proceeds to generate at least a public key for the content, based on the condition set included within the access policy 116. In one embodiment, at operation 322, the key creation module 148 may generate both a public key and a private key, based on the access policy 116, the public and private keys then being stored within an appropriate record in the policy table 200, as illustrated in FIG. 2. However, in one embodiment, only the public key may be generated at operation 322, with the private key being generated on a need to distribute basis during an access granting operation to be described in further detail below.

At operation 324, the trusted third party 304 then communicates the public key 120, via the network 108, to the content source 302, the content source 302 receiving the public key from the trusted third party at operation 326.

Accordingly, the public key generated and communicated at operation 324 constitutes an example of an encryption key, associated with a particular access policy that is to be provided to the content source 302 with which to encrypt the content 112. In other example of embodiments, other access-restricting mechanisms may be provided from the trusted third party 304 to the content source 302.

At operation 328, the content source 302, using the encryption key in the example form of the public key 120, proceeds to encrypt the content 112 to generate encrypted content 122. At operation 330, the content source 302 provides the encrypted content 122 to the content recipient 306 which, at operation 332, receives and stores the encrypted content (e.g., in a local storage).

Accordingly, it will be appreciated that the content source 302, at this point having provided the encrypted content 122 to the content recipient 306, no longer has access to the encrypted content 122, and is accordingly not able to withdraw or alter the encrypted content 122 in any way. Accordingly, this provides a guarantee to the content recipient 306 that, subsequent to the delivery of the electronic content to the content recipient 306, the content source 302 exercises no further control over the delivered content. The content source 302 at the same time is guaranteed that the content recipient 306 is unable to decrypt the delivered electronic content 122 until the access conditions, specified within the access policy, are satisfied because, as will be described in further detail below, the trusted third party 304 will not provide a decryption key to the content recipient 306 until these access conditions are satisfied.

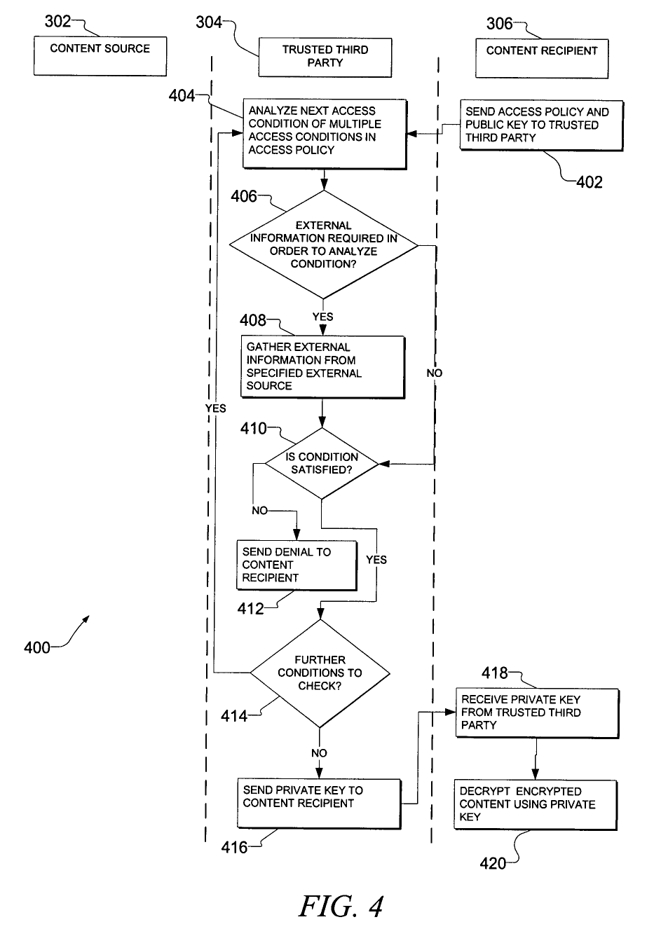

FIG. 4 is a swimlane flowchart illustrating a method 400, according to an example embodiment, to selectively grant access to electronic content to a content recipient, upon the satisfaction of certain conditions specified within an access policy. As with FIG. 3, the operations as performed by the content source 302, the trusted third party 304 and the content recipient 306 are illustrated.

The method 400 commences at operation 402 with the content recipient 306 wishing to access the encrypted electronic content 122, and accordingly sending a request to the trusted third party 304 for a decryption key that may be utilized by the decryption module 132 to decrypt the encrypted electronic content 122. In one embodiment, this request for a decryption key may comprise (1) a request for the private key 134, corresponding to the public key 120 previously provided to the content source 302, as well as (2) the condition set included within the access policy 116.

At operations 404-414, the trusted third party 304 evaluates the conditions defined by the access condition set embodied in the access policy 116. Specifically, at operation 404, the condition monitoring module 150 identifies a first access condition, of the potentially multiple access conditions within the access policy 116. The condition monitoring module 150 then, at decision operation 406, determines whether external information is required in order to analyze the given access condition.

If so, at operation 404, the condition monitoring module 150 proceeds, for example via the interface module 140 and network 108, to gather the external information from a specified external source (e.g., the external data source 152).

On the other hand, following a negative determination at decision operation 406, or on completion of the gathering of the external information at operation 408, the condition monitoring module 150, at operation 410, makes a determination as to whether the given access condition is satisfied or not. The determination of whether the access condition is satisfied at operation 410 may include evaluating the retrieved external data, or may involve, for example, execution of one or more business workflows. It will be appreciated that simple access conditions, such as the verification of a current date, may be verified without performing any external calls.

If the given access condition is determined not to be satisfied at decision operation 410, at operation 412 the condition monitoring module 150 may issue an access denial to the content recipient 306. Alternatively, the condition monitoring module 130 may simply remain silent and not issue an approval notification, which will be registered by the system as an access denial.

In the event that the given access condition is determined to be satisfied at decision operation 410, the method 400 advances to decision operation 414, where the condition monitoring module 150 determines whether the relevant access policy 116 includes any further access conditions that require analysis. If so, the method 400 loops back to operation 404.

On the other hand, should all access conditions embodied within the access policy 116 have been evaluated, the method 400 then progresses from decision operation 414 to operation 416, where the trusted third party 304 selectively provides a decryption key, in the example form of the private key 134, to the content recipient 306, based on the access conditions being satisfied. The private key 134 may be dynamically generated at operation 416, again based on the set of access conditions included within the access policy 116. Regardless of whether the private key is generated at operation 416, or at operation 322, it will be appreciated that the relevant decryption key is associated with the access policy on account of having been derived from a set of access conditions embodied within the policy.

At operation 418, the content recipient 306 then receives the decryption key, in the example form of the private key 134, from the trusted party and, at operation 420, proceeds to decrypt the encrypted content 122 to again reveal the original, unencrypted content 112. The content recipient 306 is then able to access the decrypted content 112 utilizing the content access module 130.

Use Cases

Two example use cases are now discussed for the purposes of illustration. In a first “call for tender” use case, several companies may make an offer for a realization, such as for example building a road. The call for tender process may consist of two steps. In a first step, any participants in the call for tender process may submit an offer, by completing a specified form (e.g., specified by the content recipient 306) with required details. In a second step, once the last day for submission of tenders has passed, the collecting entity (e.g., the content recipient 306) opens the different submissions (or tenders), and selects a tender that the collecting entity deems to be the most favorable. It will be appreciated that such a call for tender process may present the potential for a number of conflicts between the submitting companies, and also sometimes with the collecting entity itself. For example, a fraud potential exists in that the collecting entity may fraudulently engage in the early disclosure of offers to certain submitting entities, so as to unable the submitting entities to make a slightly more favorable offer and accordingly win the tender. It will be appreciated that, in an example deployment, the above described technology may be utilized to counter the potential for such fraud. Specifically, the collecting entity (e.g., a content recipient 306) is unable to access tenders prior to the closure of a tender submission, and would thus be unable to make early, fraudulent disclosures to favored submitting entities (e.g., content sources).

Turning now to a second use case involving a last will and testament, it may be desirable to prevent any entities from being able to access and read the content of a last will and testament, prior to the testator actually having passed away. Typically, copies of the last will and testament may be held by clerks in which a high level degree of trust is placed. Nonetheless, it will be appreciated that the potential for a trusted clerk to access a last will and testament prior to the testator passing away exists. The technology, as described above, may be deployed so as to render a clerk unable to read the last will and testament prior to the occurrence of a predetermined event specified by a condition within an access policy 116 (e.g., a passing away of the testator).

The example embodiments described above provide technical advantages over a number of prior art technologies, for example time stamping technology as well as PKI infrastructure technology. Specifically, while time stamping facilitates the proving that a certain task has been executed at a certain time, time stamping does not address the technical problem of disallowing access to data prior to the satisfaction of a certain condition (e.g., before the passing of a certain date). PKI, while allowing for the collection of data via public/private key pairs, provides no control over the time at which entity may use a decryption mechanism for example. Accordingly, the above described example embodiment addresses various technical problems that currently exist within the PKI infrastructure.

A policy-based cryptography may be used for implementing certain complex scenarios but nonetheless does not enable the “blind” storage of data (e.g., by a content recipient 306) for later use so as to ensure both the non-disclosure of the content by the content recipient 306, as well as a counteracting repudiation by a content source 302.

A Three-Tier Architecture

In some embodiments, one implementation may be as a distributed or non-distributed software application designed under a three-tier software architecture paradigm, whereby the various modules of computer code that make up the one implementation can be categorized as belonging to one or more of these tiers. A three-tier architecture is well known in the art. The first tier may be an interface level that is relatively free of application processing. The second tier may be a logic level that performs processing in the form of logical/mathematical manipulations (logical manipulations) of data inputted through the interface level, and communicates the results of these logical manipulations with the Interface and/or backend or storage level. Some example embodiments may include these logical manipulations relating to certain business rules or tasks that govern the application as a whole. These logical manipulations and associated business rules may used to implement the operations described herein.

The third tier or storage level may be a persistent storage medium, or, some example embodiments may include non-persistent storage medium. One or more of these tiers may be collapsed into one another, resulting in a two-tier architecture, or one-tier architecture. For example, the interface and logic levels may be consolidated, or the logic and storage level may be consolidated, as in the case of an application with an embedded database. This three-tier architecture may be implemented using one technology, or as will be discussed below, a variety of technologies. These technologies may include one or more object-oriented programming languages such as, for example, JAVA™, C++, DELPHI™, C#, or the like. Additionally, structured programming languages such as, for example, C, may also be used. Moreover, scripting languages such as, for example, Perl, Python, PHP, JAVASCRIPT™ or VBSCRIPT™ may also be used. This three-tier architecture, and the technologies through which it is implemented can be implemented in two or more computers organized in a server-client relationship, as is well known in the art, such that an interface level resides on a client computer, whereas a logic level resides on the application server (see below) and the storage level resides on a database server (see below). As will be discussed more fully below, in such a relationship these three tiers can be implemented as various software components that communicate via distributed programming protocols. Some example embodiments may include these three tiers being implemented in a peer-to-peer configuration, with centralized or decentralized file and data sharing, or some other suitable file sharing paradigm, such that all three tiers reside on one or more computers and each computer retrieves files and data from one another.

Interface Level

In a networked example embodiment uses a client-based browser application, whereas other embodiments may be implemented via a command line interface. Some example embodiments of a client based browser application may include an Application Programming Interface (API) implemented to allow one application to communicate with another. Some well-known client-based browser applications include NETSCAPE™, INTERNET EXPLORER™, MOZILLA FIREFOX™, OPERA™, or some other suitable browser application. Common to these browser applications is the ability to utilize a Hyper-Text Transfer Protocol (HTTP) or Secured Hyper-Text Transfer Protocol (HTTPS) to get, upload (e.g., PUT) or delete web pages and interpret these web pages which are written in HTML and/or XML. HTTP and HTTPS are well known in the art, as are HTML and XML. HTTP and HTTPS are used in conjunction with a Transmission Control Protocol/Internet Protocol (TCP/IP) protocol as described in the Open Systems Interconnection Reference Model (OSI) model, or the TCP protocol stack model, both of which are well known in the art. The practical purpose of the client-based browser application is to enable a user to interact with the application through the display of plain text, and/or interactive, dynamic functionality in the form of buttons, text boxes, scroll down bars or other objects, widgets contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages is a product of the use of the other technologies in combination with HTML and/or XML.

Some example embodiments may include using Java Server Page (JSP™), or Active Server Pages (ASP™ or ASP.NET™) (collectively server pages) to provide a user with dynamic web pages or content via their web browser. Additional technology may be implemented in the form of an additional program (e.g., routine) written in another programming language that is embedded into the HTML and/or XML code, allowing for web pages to become dynamic. Some of these additional technologies include, for example, embedded routines written in the Java programming language, the JAVASCRIPT™ language, or the VBSCRIPT™ programming language, or some other suitable programming language. These embedded routines are used to execute the aforementioned HTTP, and/or HTTPS requests (e.g., GET, PUT, and DELETE) for web pages. For example, a web page or server page may allow a user to make a rating file, or to get a record, or even to retrieve digital content.

Some example embodiments may include, for example, a GUI used and implemented via a Java Servlet, Applet, or VBSCRIPT™ or C# form, or some other suitable programming language. This form may reside on one or more of the devices 119 as a client application. Moreover, this form may contain objects such as text boxes, buttons, scroll-down bars, widgets, or some other suitable dynamic interface object. These objects, and the routines governing them, allow a user to retrieve, input, or delete content, just to name few of the functions. For example, a form may allow a user to make a rating file, or to get a record, or even to retrieve digital content.

Logic Level

Some example embodiments may include the above described web pages, and/or server pages being stored on one or more remote server computers connected to the client computer via an Internet. These remote servers can be a web server and/or application server. Web servers running JSP™ can include the APACHE™/APACHE TOMCAT™ web server. Web servers running ASP™ can include a MICROSOFT WINDOW WEB SERVER 2003™ utilizing Internet Information Services (IIS). Application servers running JSP™ can include the Orion Application Server or other J2EE™ certified application servers. Application servers running ASP™ can include WINDOWS SERVER 2003™. For example, a web server may serve a web page over a network that allows a user to enter in data. This data is then passed to an application server, wherein various methods described below are applied to this data.

In some embodiments, the logic level may be governed by a rule set written in a scripting language that controls how and when certain web pages, server pages, or pieces of content are provided to, or made accessible to, a particular user. This scripting language can be in the form of Java, Perl, Python, or some other general purpose scripting language. For example, once the logic of a JSP™ determines that a particular object (e.g., a text box) on a web page has been executed (e.g., rating record request is entered and sent), the data from this text box is inputted, and sent to a web and/or application server. It is the routine written in a scripting language that determines whether, for example, the title data is valid (e.g., that the proper title of a piece of digital content has been entered). Some example embodiments may further include a routine written in a scripting language to retrieve data from a storage, data structure, or database level. The storage level will be run by a separate database application, while, in other embodiments, a database embedded with a logic level will be implemented (e.g., a Native database).

In some embodiments, the above described client application forms may be used to interact with a logic level. For example, a C# form may take in data from a user and pass it to one of the above described web and/or application servers. Once passed to one of these servers via a network connection, various methods as described below may be applied to the data.

Storage Level

Some embodiments may include a storage level wherein tables of data are created, and data is inserted into, selected from, these tables using a Structured Query Language (SQL) or some other database-related language known in the art. These tables of data can be managed using a database application such as, for example, MYSQL™, SQLServer™, Oracle 81™ or 10G™, or some other suitable database application. These tables are organized into a Relational-Database Schema (RDS) or Object-Relational-Database Schemas (ORDS), as is known in the art. These schemas can be normalized using certain normalization algorithms so as to avoid abnormalities such as non-additive joins and other problems. Additionally, these normalization algorithms include Boyce-Codd Normal Form or some other normalization, optimization algorithm known in the art. Some embodiments may include creating a series of database tables containing data related to digital content. These tables could be distinguished based upon the author of the rating information, the author of the digital content that is actually rated, the name of the content, or some other suitable means of distinguishing the rating information.

Various data types may be implemented including strings, integers, Character Large Objects (CLOB), Binary Large Objects (BLOB) where the actual digital content may be stored with an entry or where it is stored with the digital content store database, or some other suitable data type.

Component Design

Some example embodiments may include the above described three tiers or levels being written as one or more software modules with each module contributing to the functionality of each level or tier. Common too many of these modules is the ability to generate, use and manipulate the above-described data and data sets. These modules, and associated functionality, may be used by either the client, server, or peer applications. These various modules can be implemented into the system on an as-needed basis. These modules may be written in an object-oriented-computer language such that a component oriented or object-oriented programming technique can be implemented using a Visual Component Library (VCL), Component Library for Cross Platform (CLX), Java Beans (JB), Java Enterprise Beans (EJB), Component Object Model (COM), or Distributed Component Object Model (DCOM) or other suitable technique. These modules are linked to other modules via various APIs and then compiled into one complete server and/or client application. The process for using modules in the building of client and server applications is well known in the art. Further, these modules, and the tiers that they make up, are linked together via various distributed programming protocols as distributed computing modules.

Distributed Computing Modules

Some example embodiments may include remote procedure calls being used to implement one or more of the above described levels of the three-tier architecture across a distributed programming environment. For example, a logic level resides on a first computer system that is remotely located from a second computer system containing an Interface or storage level. These first and second computer systems can be configured in a server-client, peer-to-peer or some other configuration. These various levels can be written using the above described component design principles, and can be written in the same programming language, or a different programming language. Various protocols are implemented, to enable these various levels, and components contained therein, to communicate regardless of the programming language used to write these components. For example, a module written in C++ using the Common Object Request Broker Architecture (CORBA) or Simple Object Access Protocol (SOAP) can communicate with another remote module written in JAVA™M. These protocols include SOAP and CORBA or some other suitable protocol. These protocols are well-known in the art.

### A System of Transmission Between a Server and Client

In some embodiments, the above described components that make up the platform architecture communicate using the OSI or TCP/IP stack models for defining network protocols that facilitate the transmission of data. Applying these models, a system of data transmission between a server and client computer system can be described as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications, whereas in other embodiments another protocol known in the art is utilized. Content from an application residing at the application layer is loaded into the data load field of a TCP segment residing at the transport layer. This TCP segment also contains port information for a remote recipient application module. This TCP segment is loaded into the data field of an IP or UDP datagram residing at the network layer. Next, this IP datagram is loaded into a frame residing at the data link layer. This frame is then encoded at the physical layer and the content transmitted over a network such as an Internet, Local Area Network (LAN) or Wide Area Network (WAN). The terms Internet refers to a network of networks. Such networks may use a variety of protocols for exchange of information, such as TCP/IP, ATM, SNA, SDI, etc, and may be used within a variety of topologies or structures. This network may include a Carrier Sensing Multiple Access Network (CSMA) such an Ethernet based network. This network may include a Code Divisional Multiple Access (CDMA) network, or some other suitable network.

Computer System

In some embodiments, an embodiment may be implemented entirely in executable computer program instructions which are stored on a computer-readable medium or may be implemented in a combination of software and hardware, or entirely in hardware via circuits such as logic circuits.

Embodiments may include computer-readable medium for carrying or having computer-executable instructions or data structures stored thereon. Such computer-readable medium may be any available medium which is accessible by a general-purpose or special-purpose computer system. By way of example, and not limitation, such computer-readable medium can comprise physical storage medium such as RAM, Read Only Memory (ROM), Erasable Programmable Read-Only Memory (EPROM), Compact Disk-Read Only Memory (CD-ROM), or other optical-disk storage, magnetic-disk storage or other magnetic-storage devices, or any other medium which can be used to carry or store desired program code means in the form of computer-executable instructions, computer-readable instructions, or data structures and which may be accessed by a general-purpose or special-purpose computer system. This physical storage medium may be fixed to the computer system as in the case of a magnetic drive or removable as in the case of an EEPROM device (e.g., flash memory device).

In some embodiments, when information is transferred or provided over a network or another communications connection (e.g., either hardwired, wireless, or a combination of hardwired or wireless) to a computer system, the connection is properly viewed as a transmission medium. Thus, any such connection is properly termed a transmission medium.

Computer-executable or computer-readable instructions comprise, for example, instructions and data which cause a general-purpose computer system or special-purpose computer system to perform a certain function or group of functions. The computer-executable or computer-readable instructions may be, for example, binaries, or intermediate format instructions such as assembly language, or even source code.

In this description, and in the following claims, a computer system is defined as one or more software modules, one or more hardware modules, or combinations thereof, that work together to perform operations on electronic data. For example, the definition of computer system includes the hardware modules of a personal computer, as well as software modules, such as the operating system of the personal computer. The physical layout of the modules is not important. A computer system may include one or more computers coupled via a network. Likewise, a computer system may include a single physical device (e.g., a mobile phone or PDA) where internal modules (e.g., a processor and memory) work together to perform operations on electronic data.

Some embodiments may be practiced in network computing environments with many types of computer system configurations, including hubs, routers, wireless Access Points (APs), wireless stations, personal computers, laptop computers, hand-held devices, multi-processor systems, microprocessor-based or programmable consumer electronics, network Personal Computers (PCs,) minicomputers, mainframe computers, mobile telephones, PDAs, pagers, and the like. One embodiment can also be practiced in distributed system environments where local and remote computer systems, which are linked (e.g., either by hardwired, wireless, or a combination of hardwired and wireless connections) through a network, both perform tasks. In a distributed system environment, program modules may be located in both local and remote memory-storage devices (see below).

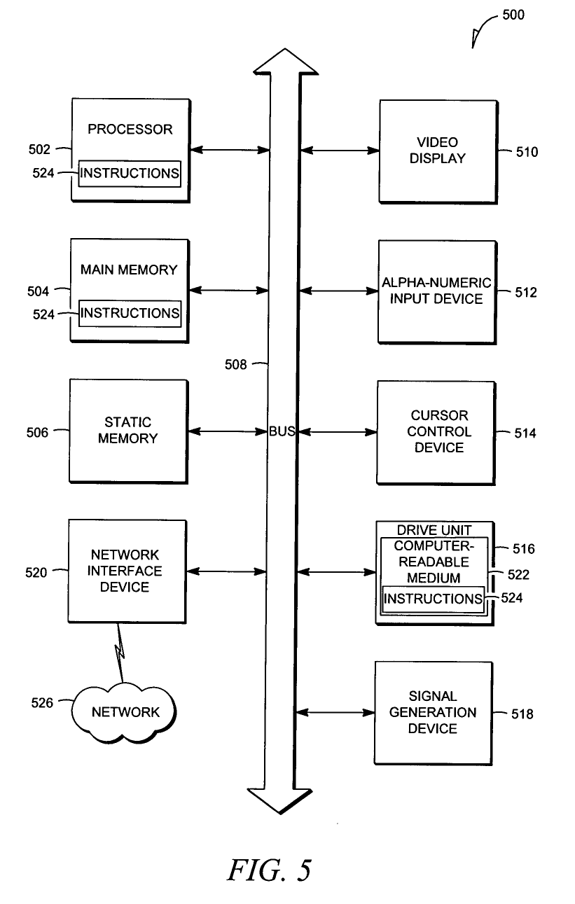

FIG. 5 shows a diagrammatic representation of a machine in the example form of a computer system 500 which executes a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 500 includes a processor 502 (e.g., a Central Processing Unit (CPU), a Graphics Processing Unit (GPU) or both), a main memory 504 and a static memory 506, which communicate with each other via a bus 508. The computer system 500 may further include a video display unit 510 (e.g., a Liquid Crystal Display (LCD) or a Cathode Ray Tube (CRT)). The computer system 500 also includes an alphanumeric input device 512 (e.g., a keyboard), a User Interface (UI) cursor controller 514 (e.g., a mouse), a disk drive unit 516, a signal generation device 518 (e.g., a speaker) and a network interface device (e.g., a transmitter) 520.

The disk drive unit 516 includes a machine-readable medium 522 on which is stored one or more sets of instructions and data structures (e.g., software) embodying or utilized by any one or more of the methodologies or functions described herein. The software may also reside, completely or at least partially, within the main memory 504 and/or within the processor 502 during execution thereof by the computer system 500, the main memory 504 and the processor 502 also constituting machine-readable media.

The instructions 522 may further be transmitted or received over a network 526 via the network interface device 520 utilizing any one of a number of well-known transfer protocols (e.g., HTTP, SIP).

While the removable physical storage medium is shown in an example embodiment to be a single medium, the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies described herein. The term “machine-readable medium” shall accordingly be taken to include, but not be limited to, solid-state memories, optical and magnetic medium.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The above description is intended to be illustrative, and not restrictive. For example, the above-described embodiments (or one or more aspects thereof) may be used in combination with each other. Other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
associating an access policy with content, the access policy specifying at least one access condition to be satisfied prior to a content recipient accessing the content;
providing an encryption key to a content source, the encryption key being associated with the access policy and to be used by the content source to encrypt the content;
at a trusted third party, determining whether the at least one access condition is satisfied; and
selectively providing a decryption key from the trusted third party to the content recipient based on the at least one access condition being satisfied, the decryption key being associated with the access policy and to be used by the content recipient to decrypt the content.

2. The method of claim 1, including defining the access policy to specify the at least one access condition.

3. The method of claim 2, wherein the content source defines the access policy.

4. The method of claim 2, wherein the content recipient defines the access policy.

5. The method of claim 1, including receiving the access policy at the trusted third party from the content source.

6. The method of claim 1, including receiving the encryption key at the content source from the trusted third party, and the content source encrypting the content using the encryption key to generate encrypted content.

7. The method of claim 6, including providing the encrypted content from the content source to the content recipient prior to the selective provision of the decryption key to the content recipient from the trusted third party.

8. The method of claim 7, including receiving the decryption key at the content recipient from the trusted third party, and decrypting the encrypted content using the decryption key.

9. The method of claim 1, wherein the encryption key is a public key derived from the access policy.

10. The method of claim 9, wherein the decryption key is a private key that is symmetrically related to the public key.

11. The method of claim 1, wherein the determining whether the at least one access condition is satisfied includes retrieving monitored information using at least one of extra-application communications and intra-application communications.

12. The method of claim 1, wherein the determining whether the at least one access condition is satisfied includes determining whether external information is required from an external source, and selectively obtaining the external information from the external source based on the determination regarding whether the external information is required.

13. The method of claim 1, wherein the determining whether the at least one access condition is satisfied is performed responsive to receipt of a request to access the content from the content recipient.

14. The method of claim 1, wherein the determining whether the at least one access condition is satisfied includes monitoring the at least one access condition.

15. The method of claim 1, including automatically providing the decryption key from the trusted third party to the content recipient when the at least one access condition is determined to be satisfied.

16. A system comprising:
a storage device to store an access policy that is associated content, the access policy specifying at least one access condition to be satisfied prior to a content recipient accessing the content;
a key module provide an encryption key to a content source, the encryption key being associated with the access policy and to be used by the content source to encrypt the content; and
a condition module determined whether the at least one access condition is satisfied,
the key module further to selectively provide a decryption key to the content recipient based on the at least one access condition being satisfied, the decryption key being associated with the access policy and to be used by the content recipient to decrypt the content.

17. The system of claim 16, including a policy creation module to facilitate definition of the access policy to specify the at least one access condition.

18. The system of claim 16, including a first interface to receive the access policy at a trusted third party from the content source.

19. The system of claim 16, including a second interface to receive the encryption key at the content source from the trusted third party, and an encryption module to encrypt the content, using the encryption key, to generate encrypted content.

20. The system of claim 19, wherein the second interface is to provide the encrypted content from the content source to the content recipient prior to the selective provision of the decryption key to the content recipient from the trusted third party.

21. The system of claim 20, including a third interface to receive the decryption key at the content recipient from the trusted third party, and a decryption module to decrypt the encrypted content using the decryption key.

22. The system of claim 16, wherein the encryption key is a public key derived from the access policy.

23. The system of claim 22, wherein the decryption key is a private key that is symmetrically related to the public key.

24. The system of claim 16, wherein the condition module is to retrieve monitored information using at least one of extra-application communications and intra-application communications.

25. The system of claim 16, wherein the condition module is to determine whether external information is required from an external source, and is to selectively obtaining the external information from the external source based on the determination regarding whether the external information is required.

26. The system of claim 16, wherein the condition module is to determine the at least one access condition is satisfied responsive to receipt of a request to access the content from the content recipient.

27. The system of claim 1, wherein the condition module is to monitor the at least one access condition.

28. The system of claim 1, wherein the key module is to automatically provide the decryption key from the trusted third party to the content recipient when the at least one access condition is determined to be satisfied.

29. A system comprising:
first means for storing an access policy that is associated content, the access policy specifying at least one access condition to be satisfied prior to a content recipient accessing the content;
second means for providing access-restriction data to a content source, the access-restriction data being associated with the access policy and to be used by the content source to prevent access to the content; and
third means for determining whether the at least one access condition is satisfied,
the second means further for selectively providing access-enabling data to the content recipient based on the at least one access condition being satisfied, the access-enabling data being associated with the access policy and to be used by the content recipient to access the content.

30. A machine-readable medium embodying instructions that, when executed by machine, caused the machine to:
associate an access policy with content, the access policy specifying at least one access condition to be satisfied prior to a content recipient accessing the content;
provide an access-restricting mechanism to a content source, the access-restricting mechanism being associated with the access policy and to be used by the content source to restrict access the content;
at a trusted third party, determine whether the at least one access condition is satisfied; and
selectively provide an access-enabling mechanism from the trusted third party to the content recipient based on the at least one access condition being satisfied, the access-enabling mechanism being associated with the access policy and to be used by the content recipient to access the content.
